(19) United States
(12) Patent Application Publication
(10) Pub. No.: US 2017/0282653 A1
(43) Pub. Date: Oct. 5, 2017

(54) CONTAINER FOR TIRE-BALANCING MATERIAL

(71) Applicant: WEGMANN AUTOMOTIVE GMBH & CO. KG, Veitshochheim (DE)

(72) Inventors: Michael Lutz, Veitchochheim (DE); Christian Bauer, Veitshochheim (DE); Diana Schmitt, Veitshochheim (DE)

(21) Appl. No.: 15/624,325

(22) Filed: Jun. 15, 2017

Related U.S. Application Data
(63) Continuation of application No. PCT/EP2015/079644, filed on Dec. 14, 2015.

(30) Foreign Application Priority Data
Dec. 16, 2014 (EP) 14198303.1

(51) Int. Cl. B60C 19/00; B65D 75/58

(52) U.S. Cl. CPC B60C 19/003; B65D 75/5811

(57) ABSTRACT

A container system for particles of a tire-balancing material has a first container for holding the particles and a second container for holding at least one accessory such as a tire-valve core. The second container is connected to the first container and a perforation is provided between the first container and the second container. The first container has a duct dimensioned to release the particles, and oriented towards the second container. The duct is sealed by the second container as a result of connection between the first and second containers. Before use, the first container is opened by separating the second container along the perforation. The opened first container is placed in a tire, where the duct facilitates a smooth flow of the particles from inside the first container into the tire. The tire-valve core is removed from the second container and applied to the wheel.

### CROSS-REFERENCE TO RELATED APPLICATIONS

This application is a continuation of the pending International Application No. PCT/EP2015/079644 filed on Dec. 14, 2015, which designates the United States and claims priority from the European Application No. 14198303.1 filed on Dec. 16, 2014. The disclosure of each of the above-mentioned applications is incorporated herein by reference.

### BACKGROUND

### 1. Field of the Invention

The invention relates to balancing of vehicular tires and, specifically, to a container or a bag configured to contain and disperse or apply a balancing material into the interior of a vehicular tire. Such balancing material may include small particles, such as small beads, which may be made of a ceramic material or silicate, for example.

### 2. Description of Relevant Art

For balancing of vehicular wheels, balancing weights (for example, discrete balancing weights) are typically attached to the rim of a wheel. As an alternative and to dynamically balance tires of vehicles, a certain amount of small particles of a balancing material (also referred to as compensation material) is placed or inserted into the tire. Unlike the balancing weights, the balancing material is not fixed to the rim. Instead, such balancing material is allowed to freely flow or move in the interior of the tire. As a result of the free movement, the balancing material is mainly accumulated in such areas of the inner surface of the tire where the tire mass is lower than in other areas—whether due to manufacturing tolerances or due to wear. By having the additional mass of the balancing (compensating) material accumulate in such target areas, the mass distribution over the outer surface of the tire is substantially equalized and evened out, leading to a substantially balanced wheel.

U.S. Pat. No. 6,249,971 B1 discloses a compensating material composition that includes an inorganic material and an organic material. The compensating material is formed or shaped into pellets or briquette(s), which can easily be inserted into the tire and which break(s) apart in the tire upon rotation of the tire to release individual particles. The disadvantage of such approach is a required complex processing of the compensating material. Furthermore, auxiliary materials have to be added to the compensating material to maintain the shape of the pellets or briquettes. These materials may cause unwanted effects (for example, they may cause a premature aging of the rubber material of the tire) and therefore may affect safety and reliability of the vehicle. Moreover, additional packaging is required to prevent disintegration of such compensating material during shipment.

U.S. Pat. No. 7,360,846 B2 discloses a method for treating a tire to balance a wheel by using a container that has a removable resilient clip and an adhesive to keep the container temporarily closed. After inserting the container into the tire, the tire has to be impacted or hit to open the container. The way the tire is impacted may be critical as the impact may either not be strong enough, or not be applied at the correct location to force the container to open. If the impact is too hard, on the other hand, it may lead to a damage of the tire itself.

### SUMMARY

The embodiments of the invention provide a method and a device for applying balancing material into a tire. The device is easy to use, it prevents loss of the balancing material during handling, and does not require any additional packaging for shipment.

In one embodiment, a first container for tire balancing material (that includes particles of the balancing material) defines an inner space or volume dimensioned to store the weight balancing material. The inner space has an opening duct which is appropriately sealed to enclose the balancing material within the first container during shipment and before the application or dispensation of the material into the tire. The first container has a perforation for breaking off the seal to allow the balancing material to flow out from inside the first container through the opening duct. Such configuration facilitates the use of a robust container that easily can withstand shipment without losing balancing material held in its inner volume. Before the use, the seal is broken off or separated from the first container to open the opening duct and allow the balancing material to flow out of or dispense from the first container.

In a related embodiment, a second container is attached to or combined with the first container (the first container, as before, being dimensioned to store the balancing material therein). The second container preferably comprises at least one accessory (which may be required for completing the wheel assembly and/or for using the balancing material itself). Such an accessory may include a tire valve core and/or a tire valve and/or a valve cap. In a specific implementation, the accessory includes the valve core having at least one means to prevent intrusion of the balancing material. Indeed, typical valve cores may be blocked when balancing material is intruding or finding its way into the valves. Therefore, it may be desirable to use specifically configured valve cores having either small openings or ducts which allow only the flow of air, but retain the balancing material outside of the valve cores at the same time. In a related implementation, there may also be some kind of filter or sieve arranged at the valve core. If the accessory includes a valve, it also includes a valve core, which is required for functioning of the valve. If the accessory includes a valve cap, it preferred that the valve cap has a special marking to allow, upon installation on a tire, the identification of such tire containing the tire-balancing material.

To obtain access to the contents of the second container, the second container preferably must be removed or separated from or torn off from the first container and, therefore, from the container system. The container system is preferably configured such that this step of separation of the second container removes or opens the seal sealing the opening duct, and therefore opens the opening duct of the first container.

In a related simplified embodiment, there is only a first container having a duct that is closed by a tab or sealing strip (which tab or sealing strip can be removed along a perforation).

The disclosed embodiments offer a simple way to use a container system configured to hold a tire-balancing material. The container system may be made of a comparatively rigid and/or solid material, which holds and protects the balancing material within the container system during shipment. Before applying the balancing material to a wheel, the person who is applying the balancing material (the user) is motivated or urged or directed to get a hold of the accessory (which is required to complete the assembly of the wheel) by removing or tearing off the second container from the first container, thereby opening the duct of the first container in the process. Therefore, it is nearly impossible for the person applying the balancing material to omit opening the duct (which omission would prevent the balancing material from flowing into the tire once the opened first container is placed into the tire). Therefore, the addition of the accessory in a second container to the first container makes the container system failure proof in use. Moreover, the addition or placement of a necessary accessory to or within the very same container system that holds or stores the balancing material to be applied to the tire, the use of an incorrect accessory (such as a wrong valve core and/or valve cap) in such tire is prevented.

The duct at the first container is shaped to prevent a dispensation or coming off of the balancing material from inside the first container at the moment when the second container is torn off and during the placement of the first container within or into the tire. As long as the first container is held upright with the duct at the top of the first container, all balancing material is forced to remain inside the first container. When the first container is placed in the tire, which is usually done in by positioning the first container horizontally, the balancing material is allowed to start flowing out of the first container and smoothly distribute within the tire. When the complete wheel (with a tire and a rim together with a valve core and/or valve cap) has been assembled and mounted to a car, more and more of the balancing material is released through the duct during the rotation of the wheel. This gradual release of the balancing material into the tire ensures an even distribution of the balancing material.

It is preferred, to have the container system made of plastic(s) and/or paper, and/or a plastic-paper composite material. It is preferred, if the plastic component of the material of the body of the container system is placed at the inner side to prevent the particles of the balancing material to penetrate through the surface of the container system. Preferably, paper is placed at the outside surface of the container system, to optionally carry printed type information and/or using instructions. Most preferably, the first and second containers are configured as bags. It is preferred, if the perforation comprises a plurality of holes, preferably small holes or slots, which may have been punched into the container. Preferably, at least one of the holes of the perforation penetrates into or through the (inner volume of the) first container and/or the (inner volume of the) second container. Such configuration may be beneficial in allowing air to exit from the first container and/or the second container when the container(s) are compressed, thereby saving space for transport and storage. Alternatively, instead of the perforation any predetermined breaking point or area may be defined between the first and second containers.

A related embodiment provides to a system for tire balancing. The system includes at least one of container described previously. Preferably, the first container contains particles of a tire-balancing material (which may contain metal, ceramics, and/or sand). The second container, when present, may contain at least one accessory, which preferably may be a tire valve core and/or a tire valve and/or a valve cap.

Yet another embodiment provides a method for applying balancing material to a wheel. The method includes the steps of opening a first container of a container system by removing or separating or tearing off a second container from a first container along a perforation; placing the first container within a tire; and releasing the balancing material from the first container through a duct into the tire. There may be an additional step of selecting an appropriate size of balancing material from a selection of different sizes of balancing material.

### BRIEF DESCRIPTION OF THE DRAWINGS

In the following, the invention will be described by way of example, without limitation of the general inventive concept, on examples of embodiment and with reference to the drawings.

FIG. 1 shows one embodiment of the invention.

FIG. 2 shows an open first container of an embodiment of the invention.

FIG. 3 shows a slightly modified (as compared to that of FIG. 1) embodiment of a container system.

FIG. 4 shows an embodiment with one container.

FIG. 5 shows an embodiment with two connected containers.

FIG. 6 shows an embodiment with an additional seal.

FIG. 7 shows a sectional view through the first container of the embodiment.

FIG. 8 shows a sectional view through the duct of the embodiment.

FIG. 9 shows a sectional view through the second container (illustrating additionally, an accessory contained within the second container).

FIG. 10 shows a tire with a first container.

It is appreciated that embodiments of the invention can be modified and altered as appropriate, and that only specific embodiments are shown as examples in the drawings and described below in detail. It should be understood, however, that the drawings and detailed description are not intended to limit the invention to the particular specific form(s), but to the contrary, the intention is to cover all modifications, equivalents and alternatives falling within the spirit and scope of the present invention as defined by the appended claims.

### DETAILED DESCRIPTION

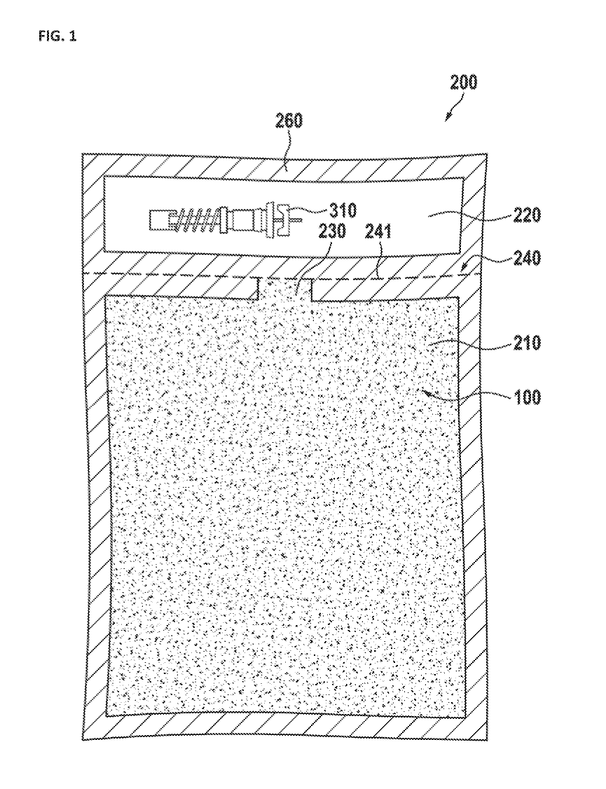

FIG. 1 illustrates an embodiment of a container system 200, which includes a first container 210 and a second container 220. The first container 210 has a duct 230 oriented towards the second container 220. Preferably, the second container 220 contains at least one accessory 310, which comprises a tire valve core and/or a tire valve and/or a valve cap. Furthermore, a perforation 240 is formed between the first container 210 and the second container 220 such that when the second container is separated from the first container along the perforation, the duct 230 is opened. The perforation is formed by a plurality of holes 241, preferably small holes or slots, which may have been punched into the container system. As long as the first container is held upright with the duct 230 to the top, the balancing material remains in the first container even when the duct is open. The first container is then placed in a tire, whereby the balancing material slowly flows out of the first container 210 through the duct 230. It is preferred to have the container system made of plastics and/or paper, and/or a combination thereof. Most preferably, it is configured as a paper-plastic composite bag. It is preferred, if the system has a sealing element 260, which is used to seal first and a second sheets of material that form, during the fabrication of the system, enclosure(s) of the a first container and a second container. The sealing element may be glued, stemmed, welded, or made by another technology to seal the container system. It may be preferred, if at least one of the holes 241 of the perforation 240 penetrates into or through the first container 210 and/or the second container 220. Such arrangement may be chosen to allow air to exit from the inner space of the first container and/or the second container, for example to allow the container(s) to be compressed, which may save space for transport and storage.

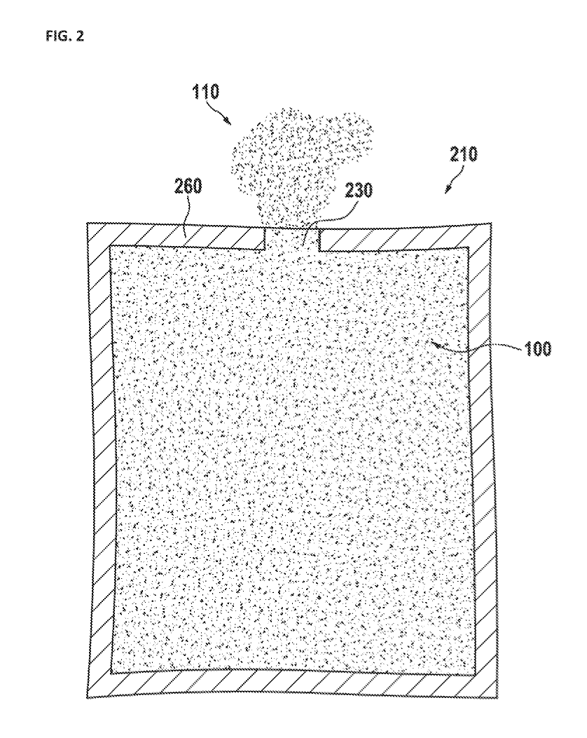

In FIG. 2, a first container with an open duct 230 is shown. The balancing material 100 is illustrated to be flowing out 110 of the container into the tire.

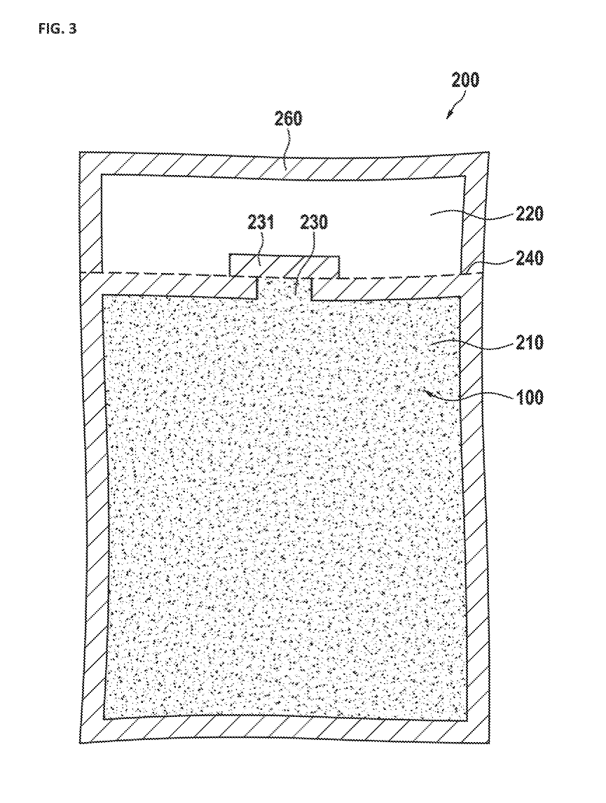

In FIG. 3, a slightly modified embodiment of a container system is shown. Here, the duct 230 is covered with a cover 231 (which may also be part of the container system). The duct seal 231 is separated by the perforation 240 from the duct and, therefore, can be torn off when removing the second container 220 of the system.

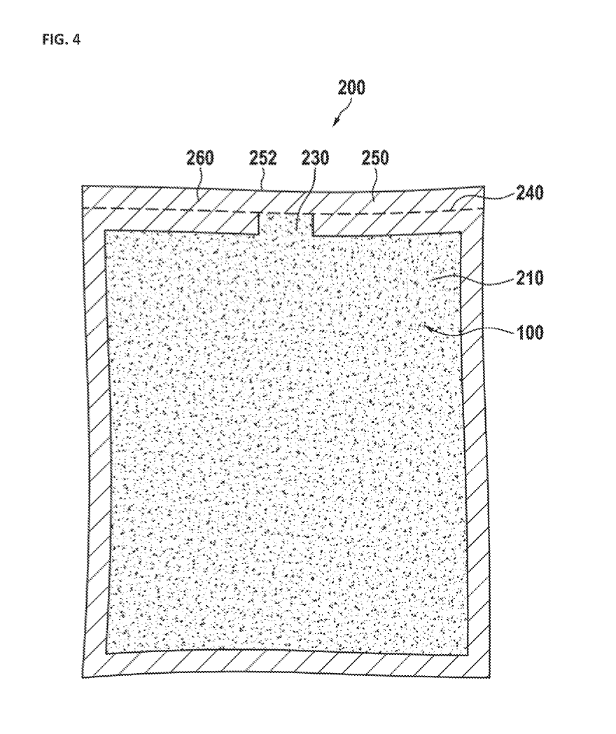

In FIG. 4, an embodiment with only one container is shown. Here, a sealing strip 232 is included, which can be removed from the container system by removing or tearing it off at the perforation 240.

In FIG. 5, an embodiment with a first container 210 connected to a second container 220 is shown. Here, the duct 230 is not closed. Instead, the second container 220 serves as a cover for the duct. Therefore, while the balancing material may flow into the second container 220, the flow of it outside of the container system is prevented. By tearing off the second container 220 from the first container 210, the duct 230 is again opened and balancing material may flow to the outside.

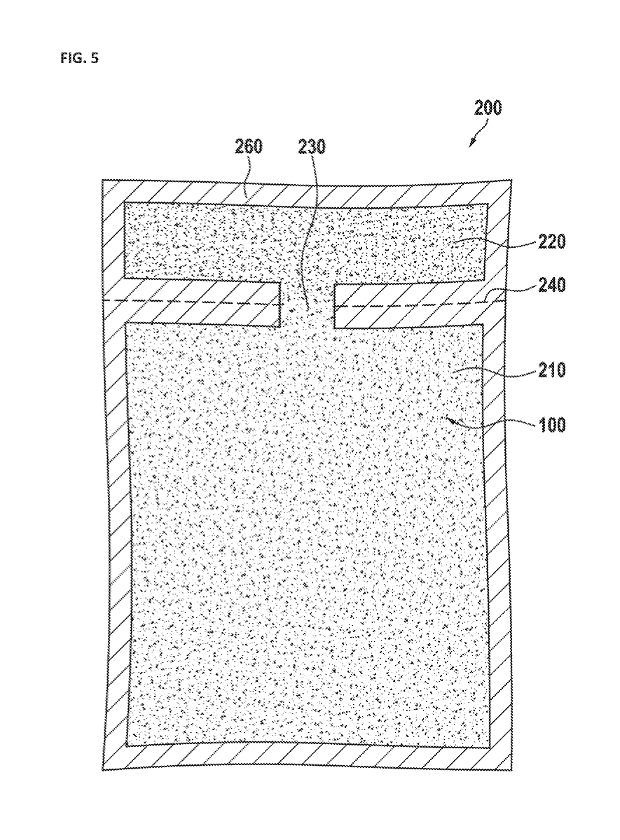

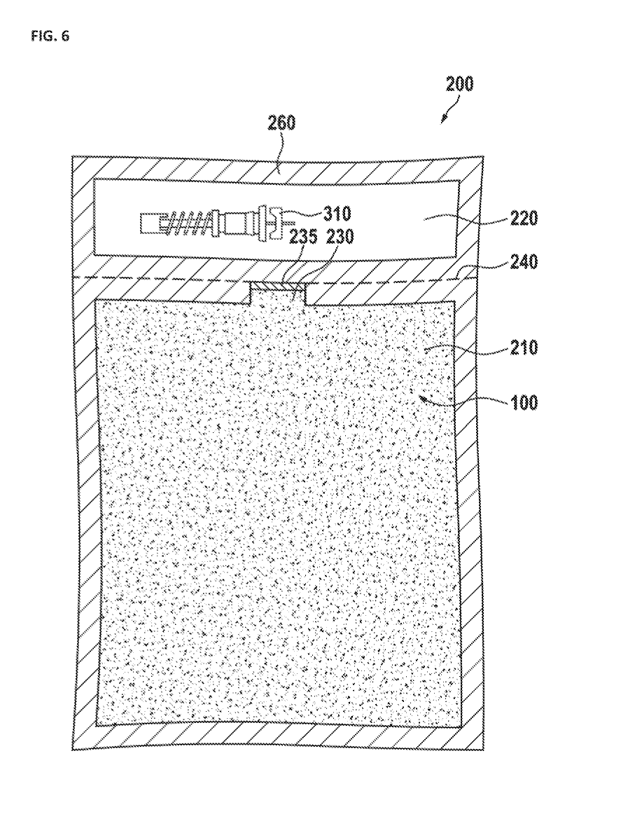

In FIG. 6, an embodiment with an additional seal 235 at the duct is shown. This seal may be a small piece of adhesive tape, or it may be of the same material as the container system is. This seal may open, when the container is placed in a tire.

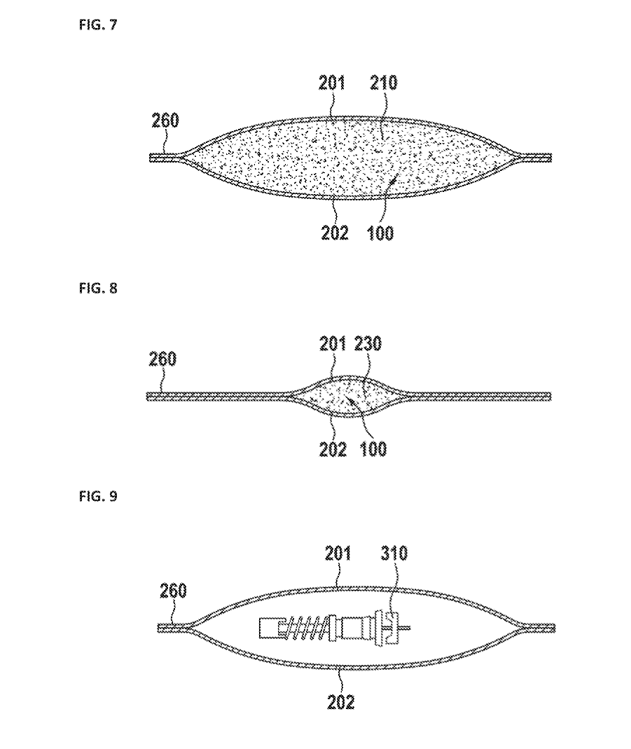

In FIG. 7, a sectional view through the first 210 container is shown. Here, the container system as well as the first container 210 comprises or is formed with a first layer 201 and a second layer 202, which layers are connected together at the rim 260. The layers preferably are made of paper and/or plastic(s), and/or a combination thereof. The first container is enclosing balancing material 100.

In FIG. 8, a sectional view through the duct 230 is shown. Here, again, the first layer 201 and the second layer 202 can be seen.

In FIG. 9, a sectional view through the second container is shown. Here, between the first layer 201 and the second layer 202, an accessory 210 like a valve may be enclosed as shown.

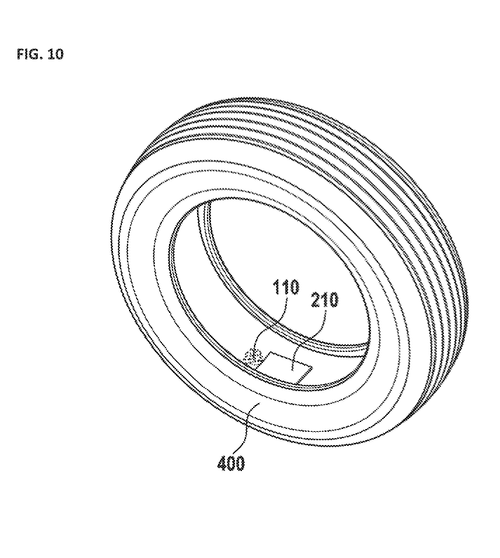

FIG. 10 shows a tire 400 with a first container 210 and particles of balancing material flowing out of the first container.

It will be appreciated to those skilled in the art having the benefit of this disclosure that this invention is believed to provide a method, a container or a bag for containing and applying a balancing material into the interior of vehicular tires. Further modifications and alternative embodiments of various aspects of the invention will be apparent to those skilled in the art in view of this description, Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

100 balancing material
110 balancing material outside of container
200 container system
201 first layer
202 second layer
210 first container
220 second container
230 duct
231 duct seal
232 sealing strip
235 additional seal
240 perforation
241 hole of perforation
260 rim
310 accessory
400 tire

1. A container system configured to hold particles of a tire-balancing material, the container system comprising:
a first container dimensioned to store the particles therein, the first container having a duct dimensioned to release the particles from the first container; and
a second container configured to hold at least one accessory therein;
wherein the second container is attached to the first container along a perforation provided therebetween to seal the duct, and
wherein the container system is made of (i) paper or (ii) a combination of paper and plastic material.

2. The container system according to claim 1, wherein the duct is configured to be opened by separating or tearing off the second container from the first container along the perforation.

3. The container system according to claim 1, further comprising a duct seal disposed to seal the duct.

4. The container system according to claim 1, wherein the at least one accessory is a tire valve core or a tire valve cap.

5. The container system according to claim 1, wherein the perforation comprises a plurality of holes.

6. The container system according to claim 5, wherein at least one of the holes of said plurality penetrates into an inner volume of the first container.

7. The container system according to claim 5, wherein at least one of the holes of said plurality penetrates into an inner volume of the second container.

8. A system for balancing a tire, the system comprising:
a container system configured to hold particles of a tire-balancing material, the container system including
a first container dimensioned to store the particles in an inner volume thereof, the first container having a duct dimensioned to release the particles from the first container; and
a second container configured to hold at least one accessory and connected to the first container along a perforation between the first and second containers to seal said duct,
wherein the container system is made of (i) paper, or (ii) a combination of paper and plastic material, or (iii) a composite material comprising a plastic material and paper, and
said particles, contained in the inner volume of the first container.

9. The system for balancing the tire according to claim 8, further comprising at least one accessory disposed in the second container.

10. A method for applying particles of a tire-balancing material into a tire, the method comprising:
providing a container system that includes:
a first container dimensioned to store said particles therein and having a duct,
a second container connected to the first container along a perforation to seal the duct, the second container dimensioned to holding at least one accessory;
removing the second container from the first container along the perforation and thereby opening the duct, and
placing the first container in the tire.

11. A method according to claim 10, wherein said providing includes providing the container system comprising:
a first container dimensioned to store the particles therein, the first container having a duct dimensioned to release the particles from the first container; and
a second container configured to hold at least one accessory therein;
wherein the second container is attached to the first container along a perforation provided therebetween to seal the duct, and
wherein the container system is made of (i) paper or (ii) a combination of paper and plastic material or (iii) a composite material including a plastic material and paper.

12. The method according to claim 11, further comprising: removing the at least one accessory from the second container and applying the at least one accessory to the tire.

13. The method according to claim 12, wherein the removing includes at least one of a tire valve core and a valve cap from the second container.

14. A container system configured to hold particles of a tire-balancing material, the container system comprising:
a first container dimensioned to store the particles therein and having a duct dimensioned to release the particles from the first container; and
a second container configured to hold at least one accessory and connected to the first container along a perforation therebetween to seal the duct;
wherein the perforation comprises a plurality of holes and
wherein at least one of the holes from said plurality penetrates into at least one of (i) an inner volume of the first container—and (ii) an inner volume of the second container.

15. The container system according to claim 14, wherein the duct is configured to be opened by separating or tearing off the second container from the first container along the perforation.

16. The container system according to claim 14, further comprising a duct seal disposed to seal the duct.

17. The container system according to claim 14, wherein the at least one accessory is a tire valve core or a valve cap.

18. The container system according to claim 14, wherein the container system is made of (I) paper or (ii) a combination of paper and a plastic material or (iii) a composite material comprising a plastic material and paper.
